(19) United States
(12) Patent Application Publication
(10) Pub. No.: US 2025/0070652 A1
(43) Pub. Date: Feb. 27, 2025

(54) DAMPING FILTERS FOR REDUCED ELECTROMAGNETIC EMISSIONS

(71) Applicant: Apple Inc., Cupertino, CA (US)

(72) Inventors: Madhur S Bhattacharya, Sunnyvale, CA (US); Juntao Yao, San Jose, CA (US)

(21) Appl. No.: 18/453,606

(22) Filed: Aug. 22, 2023

(51) Int. Cl. H02M 1/44; H02M 1/12

(52) U.S. Cl. CPC H02M 1/44; H02M 1/123; H02P 27/06

(57) ABSTRACT

An electrical system can include an inductive load; a switching converter that receives power from a power source and converts it to a voltage or current level suitable for the inductive load; a wiring harness having a first end coupled to an output of the switching converter and a second end coupled to the inductive load; and an RC filter network coupled to at least one end of the wiring harness, the RC filter network having a filter capacitance and a damping resistance, wherein the filter capacitance and damping resistance are selected to reduce common mode noise caused by conducted electromagnetic emissions associated with switching operation of the switching converter. The RC filter network can further include one or more series combinations of the filter capacitance and the damping resistance.

### BACKGROUND

In some electrical systems, switching converters may be used to drive inductive loads, with the converter and load being connected by a wiring harness. In some applications, the physical configuration of the wiring harness may give it an impedance (such as an inductance) that can allow for increased conducted electromagnetic interference (EMI) that can manifest as common mode noise voltages and/or currents.

### SUMMARY

In some cases, it may therefore be desirable to provide for filtering circuitry that can reduce the conducted EMI/common mode noise. This can take the form of additional inductive or capacitive reactances that offset the effects of the impedance of the wiring harness. However, these additional reactances can result in a resonant frequency that can exacerbate noise issues associated with the switching operation of the switching converter. Including damping resistances in the filtering circuitry to form filter/damping circuitry can help to overcome such issues.

An electrical system can include an inductive load; a switching converter that receives power from a power source and converts it to a voltage or current level suitable for the inductive load; a wiring harness having a first end coupled to an output of the switching converter and a second end coupled to the inductive load; and an RC filter network coupled to at least one end of the wiring harness, the RC filter network having a filter capacitance and a damping resistance, wherein the filter capacitance and damping resistance are selected to reduce common mode noise caused by conducted electromagnetic emissions associated with switching operation of the switching converter.

The RC filter network can further include one or more series combinations of the filter capacitance and the damping resistance. The series combinations of the filter capacitance and the damping resistance can couple each power conductor of the wiring harness to a signal ground associated with the switching converter or a chassis ground associated with the electrical system. The RC filter network can be coupled in parallel with the wiring harness coupling a first end of each power conductor of the wiring harness to a second end of each power conductor of the wiring harness. The electrical system can further include at least one of a first inductance coupled between the output of the switching converter and the first end of the wiring harness and a second inductance coupled between the second end of the wiring harness and the inductive load. At least one of the first and second inductances can be selected from the group consisting of: discrete inductors, ferrite beads, and a common mode choke. The electrical system can further include a filter coupled between an input of the switching converter and the power source. The switching converter can be an inverter. The inductive load can be a motor or a solenoid.

An electrical system can include an inductive load; a switching converter that receives power from a power source and converts it to a voltage or current level suitable for the inductive load; a wiring harness having a first end coupled to an output of the switching converter and a second end coupled to the inductive load; a first output inductance coupled between the switching converter and the first end of the wiring harness; and an RC filter network coupled to the first output inductance and the first end of the wiring harness, the RC filter network further comprising a filter capacitance and a damping resistance selected to reduce common mode noise caused by conducted electromagnetic emissions associated with switching operation of the switching converter.

The electrical system can further include a filter coupled between the switching converter and the power source. The filter coupled between the switching converter and the power source can be an input inductance. The first output inductance can be a common mode choke. The electrical system can further include a second output inductance coupled between the second end of the wiring harness and the inductive load. The RC filter network can further include a series combination of a filter capacitance and a damping resistance coupling each power conductor of the wiring harness to a signal ground associated with the switching converter or a chassis ground associated with the electrical system.

An electrical system can include an inductive load; a switching converter that receives power from a power source and converts it to a voltage or current level suitable for the inductive load; a filter coupled between the switching converter and the power source; a wiring harness having a first end coupled to an output of the switching converter and a second end coupled to the inductive load; and an RC filter network coupled to at least one end of the wiring harness, the RC filter network having a filter capacitance and a damping resistance selected to reduce common mode noise caused by conducted electromagnetic emissions associated with switching operation of the switching converter. The filter coupled between the switching converter and the power source can be an input inductance. The RC filter network can couple each power conductor of the wiring harness to a signal ground associated with the switching converter or a chassis ground associated with the electrical system. The RC filter network can be coupled in parallel with the wiring harness coupling a first end of each power conductor of the wiring harness to a second end of each power conductor of the wiring harness.

### BRIEF DESCRIPTION OF THE DRAWINGS

FIG. 1 illustrates an electrical system having a switching converter driving a wiring harness having sufficient length to potentially contribute to common mode noise.

FIG. 2 further illustrates an electrical system having a switching converter driving a wiring harness having sufficient length to potentially contribute to common mode noise, with added common mode noise filtering and damping circuitry.

FIG. 3A is a simplified schematic illustrating an electrical system having a switching converter driving a wiring harness having sufficient length to potentially contribute to common mode noise, with added common mode noise filtering and damping circuitry.

FIG. 3B is a plot illustrating common mode current noise reduction for an exemplary electrical system.

FIG. 3C is a plot illustrating common mode voltage noise reduction for an exemplary electrical system.

FIG. 4 illustrates one embodiment of common mode noise filtering and damping circuitry for an electrical system having a switching converter driving a wiring harness.

FIG. 5 illustrates an alternative embodiment of common mode noise filtering and damping circuitry for an electrical system having a switching converter driving a wiring harness.

FIG. 6 illustrates another alternative embodiment of common mode noise filtering and damping circuitry for an electrical system having a switching converter driving a wiring harness.

FIG. 7 illustrates yet another alternative embodiment of common mode noise filtering and damping circuitry for an electrical system having a switching converter driving a wiring harness.

FIG. 8 illustrates a generalized diagram of an electrical system having a switching converter driving a wiring harness having sufficient length to potentially contribute to common mode noise, with added common mode noise filtering and damping circuitry as described herein.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one.” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

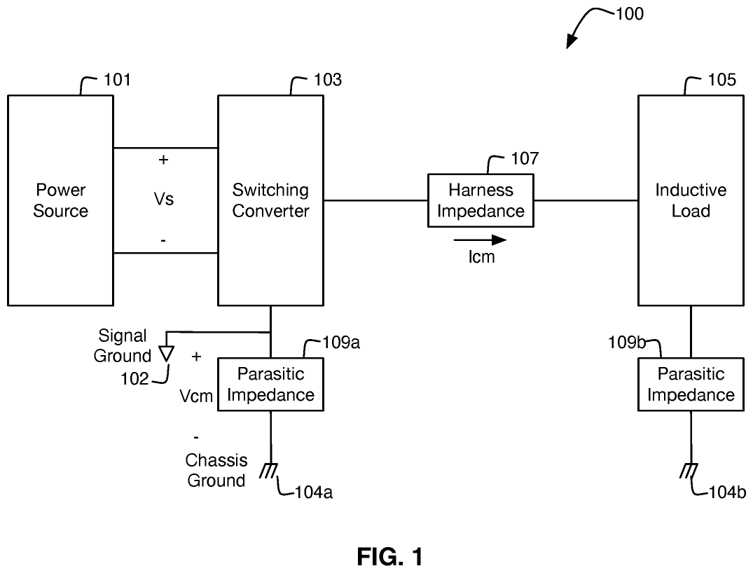

FIG. 1 illustrates an electrical system 100 having a switching converter 103 driving an inductive load 105 via wiring harness 107 having sufficient length to potentially contribute to common mode noise. Such electrical systems may exist in a variety of applications. As but one example, electrical vehicle systems may employ wiring harnesses having relatively long wiring harness driving an inductive load, such as a motor, solenoid, etc. Many other examples are possible. Electrical system 100 can include a power source 101. Power source 101 can be an AC source or a DC source that supplies a source voltage Vs. In the vehicular system example mentioned above, power source 101 may be a high voltage battery (i.e., a DC source) although the teachings herein are applicable to any power source. Power source 101 can provide power to a switching converter 103. Switching converter 103 can convert power received from power source 101 into a form suitable for powering a load, such as inductive load 105. This can include producing a regulated output voltage and/or regulated output current that are suitable for the load, which may vary in response to loading conditions, etc.

In some embodiments, the switching converter can be an inverter that converts a DC voltage received from the power source to an AC voltage to drive the load. In other embodiments, the switching converter could be a DC-DC converter that converts a DC voltage received from power source 101 into a suitable voltage for a load 105. In the case of an inverter, switching converter can have a number of topologies, such as half-bridge or full-bridge inverter, and could be single-phase, split-phase, three-phase, or polyphase. Likewise in the case of a DC-DC converter, switching converter can have various topologies, such as a buck (step-down) converter, boost (step-up) converter, forward resonant converter, etc. The teachings herein are applicable to any such converters, and thus the construction details of switching converter 103 are not discussed in detail herein.

Switching converter 103 can have its own ground reference, denoted signal ground 102 in FIG. 1. This ground reference (signal ground 102) may also be coupled to a chassis ground 104a. Chassis ground 104a can be the ground reference for electrical system 100 as a whole. This may be an earth ground in some applications or may be a chassis ground that is not bonded to earth ground in other applications. The coupling between signal ground 102 and chassis ground 104a can be via a parasitic impedance 109a. This parasitic impedance may come, for example, from the impedance of a grounding strap that couples a case or housing of switching converter 103 to the chassis ground 104a. In some applications, the inductance component of parasitic impedance 109a can combine with the load impedance (discussed below) and wiring harness impedance (discussed above) to contribute to common mode noise issues.

Switching converter 103 can drive a load, such as inductive load 105, via a wiring harness 107. Such wiring harnesses can be used in many applications to route one or more conductors between two or more devices. The wiring harness may include multiple conductors having sufficient length to reach the load (or other destination). Wiring harness 107 may have a certain impedance associated therewith. For example, the wiring harness may exhibit a resistance that is proportional to its length and inversely proportional to the cross-sectional area of the conductors. Additionally, wiring harness 107 may also exhibit reactance, which can be a combination of capacitive reactance caused by capacitive coupling between the conductors and/or inductive reactance caused by the inductance (including both self-inductance and mutual inductance) between the conductors. The resistive and reactive components may change both with length of wiring harness 107 and with the operating frequency of switching converter 103. In some cases, these reactive components may also be affected by the routing of the harness, i.e., the shape of the path that the conductors take. In general, a combination of increasing length of the wiring harness and/or increasing switching frequency of switching converter 103 can contribute to common mode noise issues in electrical system 100.

Electrical system 100 can include a load, such as inductive load 105, that receives power from power source 101 via switching converter 103. Inductive loads are common in many applications. Electric motors are one example of an inductive load. Solenoids are another example. Many other types of inductive loads are also possible. In the exemplary electrical system 100, inductive load 105 is coupled to a chassis ground 104b via a parasitic impedance 109b. As described above, the chassis ground is the ground reference for the electrical system as a whole, which may be an earth ground in some applications, or may be a chassis ground that is not bonded to earth ground in other applications. This parasitic impedance may come, for example, from the impedance of a grounding strap that couples a case or housing of inductive load 105 to the chassis ground 104b. In some applications, the inductance component of parasitic impedance 109b can combine with the load impedance and wiring harness impedance to contribute to common mode noise issues.

The inductance or inductive reactance of inductive load 105 can combine with the impedance of wiring harness 107 and the parasitic impedances 109a and 109b to contribute to common mode noise issues associated with operation of switching converter 103. For example, the impedances of inductive load 105, wiring harness 107, and parasitic impedances 109a/109b can combine to produce a resonant frequency for the overall system. If this resonant frequency is sufficiently close to the switching frequency of switching converter 103, noise associated with the switching operation can manifest itself as common mode noise in the form of a common mode noise current Icm (illustrated as flowing through the harness 107) and/or across the parasitic impedance 109a (i.e., between signal ground 102—the “internal” ground of switching converter 103—and chassis ground 104a. In many applications, this common mode noise, in the form of conducted electromagnetic emissions, may be exacerbated by various physical parameters associated with the wiring harness, including length, routing, etc. Thus, it may be desirable to provide some sort of filtering and/or damping to mitigate these issues.

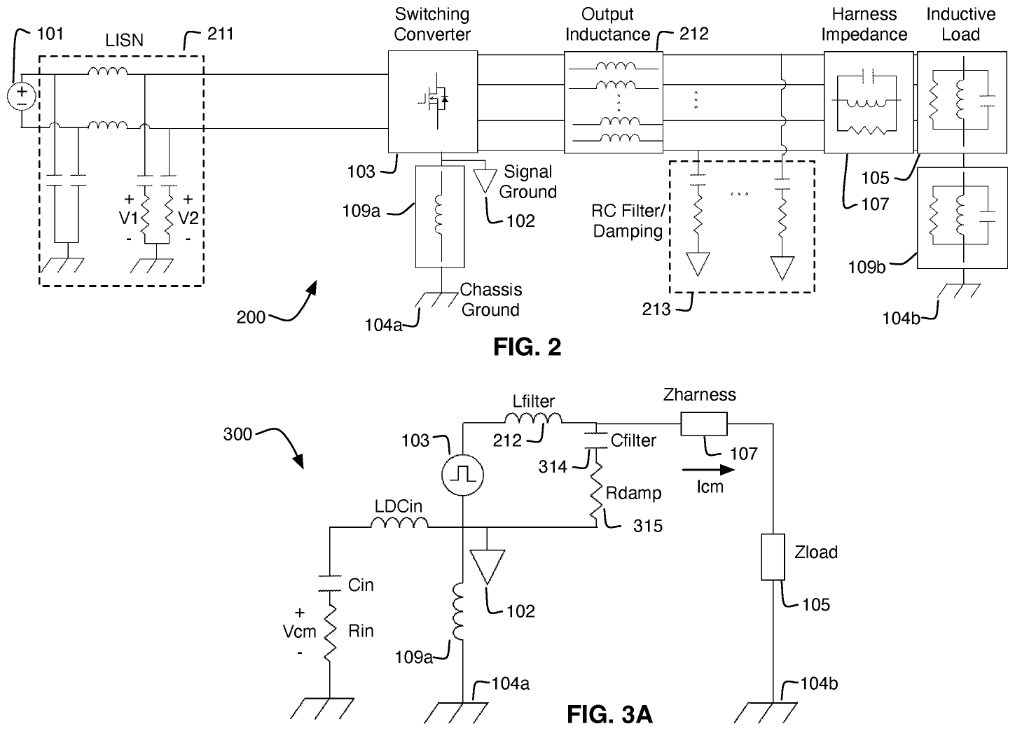

FIG. 2 illustrates an electrical system 200 having a switching converter 103 driving a wiring harness 107 having sufficient length to potentially contribute to common mode noise, with added common mode noise filtering and damping circuitry including output inductance 212 and RC filter/damping circuitry 213. Electrical system 200 generally corresponds to electrical system 100 described above with like components having the same reference numbers. Thus, electrical system 200 receives power from a power source 101. Power source 101 can be coupled to the input of switching converter 103 by a line impedance stabilization network (“LISN”) 211. A line impedance stabilization network can be used as part of electromagnetic interference testing to provide a stable input impedance to allow for accurate and repeatable testing. Such devices may not be included in the actual implementations of the electrical system, thus being used for testing only. Although each of the following embodiments illustrate the presence of a LISN, they need not be physically present in all implementations. In the illustrated example, voltage source 101 is a single-phase voltage source, and the positive/line to ground RC network has a voltage V1 appearing across a resistor. Likewise in the illustrated example, the negative/neutral to ground RC network has a voltage V2 appearing across a resistor. These voltages correspond to the common mode noise voltage, as discussed in greater detail below.

Electrical system 200 can also include a switching converter 103 as described above with reference to FIG. 1. Switching converter 103 can be coupled to its own ground reference 102, which, in turn, can be coupled to chassis ground 104a via a parasitic impedance 109a. Parasitic impedance 109a is illustrated in FIG. 2 and the following figures as an inductor/inductance, as for many applications the inductive component of parasitic impedance 109a may be most relevant, and at some points in the following discussion may be described as a parasitic inductance. Nonetheless, in some applications, the capacitive and/or resistive components of such an impedance may be more relevant. Thus, the use of an inductance symbol or referring to this parasitic impedance 109a as an inductance should not be interpreted as detracting from the generality of the previously described impedance.

The output of switching converter 103 can be coupled to inductive load 105 via a harness 107, as described above. In FIG. 2, both harness 107 and inductive load 105 are depicted as RLC circuits to denote that they each have a complex impedance associated therewith, although the particular parallel RLC configuration indicated is merely for illustration and should not be interpreted as denoting a particular equivalent circuit structure or reactance for these elements. Also depicted in FIG. 2 is parasitic impedance 109b that couples inductive load 105 to chassis ground 104b, as described above. Like wiring harness 107 and inductive load 105, parasitic impedance 109b is depicted as an RLC circuit, although, again, the illustrated parallel RLC circuit is merely illustrative and should not be interpreted as denoting a particular equivalent circuit structure or reactance. In some applications it may be that the inductance of parasitic impedance 109b is most relevant, although this need not be the case.

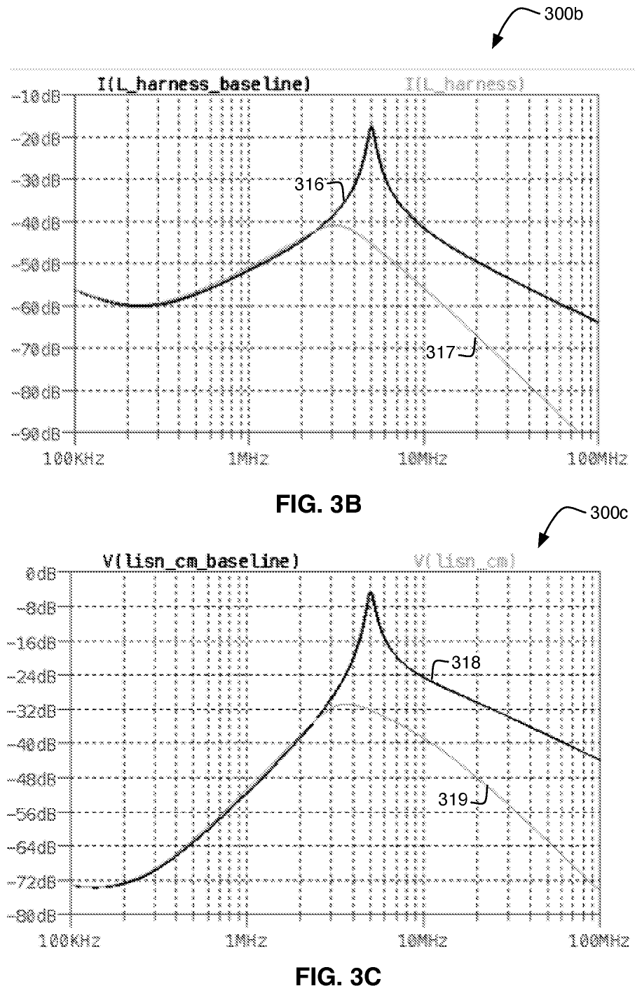

Finally, electrical system 200 includes filtering and damping elements to help mitigate the common mode noise issues described above. More specifically, electrical system 200 includes an output inductance 212 placed between the output of switching converter 103 and wiring harness 107. As illustrated in the various embodiments described below, such inductance may take various forms and can be placed anywhere in series with the switching converter 103, wiring harness, and/or inductive load 105. In fact, in some cases, output inductance 212 can be the inductance of wiring harness 107 itself. In any case, this inductance can help to reduce conducted electromagnetic emissions in the form of a common mode current Icm as illustrated above in FIG. 1 and below in FIG. 3A by providing a high impedance path to high frequency currents that would otherwise propagate back through switching converter 103. Additionally, filtering capacitors may be provided, e.g., as part of RC filter/damping circuit 213. In the illustrated example, RC filter/damping circuitry 213 is depicted as a series RC circuit coupling each phase of the coupling between the output switching converter 103 and the inductive load 105 to signal ground 102. More specifically, in FIG. 2, the connection is between output inductance 212 and wiring harness 107, although as illustrated in various other configurations described below, the RC filter/damping circuitry 213 can be connected in a variety of ways. The capacitive reactance associated with these capacitors can also filter common mode noise by shunting high frequency signals to ground.

One potential issue with the use of such LC filter circuits to prevent high frequency common mode conducted electromagnetic interference (i.e., common mode noise) from propagating back through switching converter 103 and manifesting as the signals described above is the resonant frequency of the combined reactances. More specifically, the various complex impedances described above can combine with the output inductance 212 and filter capacitances to form a resonant frequency. In some cases, this resonant frequency may be close to the operating frequency of electrical system 200 and/or the switching frequency of switching converter 103. To mitigate effects of this resonance, damping resistors may also be provided as part of RC filter/damping circuitry 213. In the illustrated embodiment, these damping resistors are in series with the above-described filter capacitors, although other configurations could also be used, and the various embodiments described below illustrate specific examples of how such circuitry can be configured.

FIG. 3A is a simplified schematic 300 illustrating a model of an electrical system having a switching converter 103 driving a wiring harness 107 having sufficient length to potentially contribute to common mode noise, with added common mode noise filtering and damping circuitry in the form of filter inductor 212, filter capacitor 314, and damping resistor 315. In the schematic of FIG. 3A, switching converter 103 is illustrated as a voltage source, directly coupled to its own ground (i.e., signal ground 102), and coupled to the chassis ground 104a via parasitic impedance 109a (depicted as an inductance, as described above with reference to FIG. 2). Switching converter 103 is also coupled to the chassis ground through power source 101 via the equivalent circuit of LISN 211, depicted as the series RLC circuit including inductor/inductance LDCin, capacitor/capacitance Cin, and resistor/resistance Rin. These circuit elements are not discrete physical elements, but rather an equivalent circuit model of the LISN 211 illustrated in FIG. 2. The common mode noise voltage Vcm is illustrated as appearing across the resistance Rin, and corresponds to voltages V1 and V2 discussed above with respect to FIG. 2. More specifically, Vcm=(V1+V2)/2.

With further reference to FIG. 3A, the output of switching converter 103 is coupled to wiring harness 107 via the output inductance 212 (as described above), with the RC filter/damping network 213 represented by its component filter capacitance 314 and damping resistor 315, which couple the output of switching converter 103 (and more specifically the output side of filter inductor 212) to signal ground 102, i.e., the internal ground reference of switching converter 103. Similarly, wiring harness 107 is represented by its equivalent impedance Zharness, and inductive load 105 is represented by its equivalent impedance Zload. Parasitic impedance 109b is not specifically depicted in FIG. 3A, although its equivalent impedance could be incorporated in Zload and/or Zharness. Current Icm represents the common mode noise voltage flowing through harness 107.

The simplified equivalent circuit model depicted in FIG. 3A may be used to illustrate an exemplary improvement in common mode noise (i.e., conducted electromagnetic interference) as shown in FIGS. 3B and 3C. More specifically, FIG. 3B is a plot 300b illustrating common mode current noise reduction for an exemplary electrical system. Trace 316 illustrates an exemplary common mode current as a function of frequency. The illustrated current is in decibels relative to the load current, and peaks at a frequency of about 5 MHz. The specific current values and frequencies are not critical to the general principle, but what is clearly illustrated by this specific example is the peak of the current appearing at 5 MHZ, which can be the resonant frequency resulting from the inclusion of output inductance 212 and the filter capacitances in the circuit as described above with reference to FIGS. 2 and 3A. Trace 317 illustrates an exemplary common mode current when the damping resistors are included as described above. The illustrated current is in decibels relative to the load current, and peaks at a frequency of about 3 MHz. Thus, this both lowers the resonant frequency and substantially reduces the peak noise current.

FIG. 3C is a plot illustrating common mode voltage noise reduction for an exemplary electrical system. Trace 318 illustrates an exemplary common mode voltage as a function of frequency. The illustrated voltage is in decibels relative to the nominal LISN voltage, and peaks at a frequency of about 5 MHZ (as described above). The specific voltage values and frequencies are not critical to the general concept illustrated, but what is clearly illustrated by this example is the peak of the voltage appearing at 5 MHZ (corresponding to the current peak/peak noise point), which can be the resonant frequency resulting from the inclusion of output inductance 212 and the filter capacitances in the circuit as described above with reference to FIGS. 2 and 3A. Trace 319 illustrates an exemplary common mode voltage when the damping resistors are included as described above. The illustrated voltage is in decibels relative to the LISN voltage, and peaks at a frequency of about 3 MHZ (as with the current). Thus, this both lowers the resonant frequency and substantially reduces the peak noise voltage, as described above.

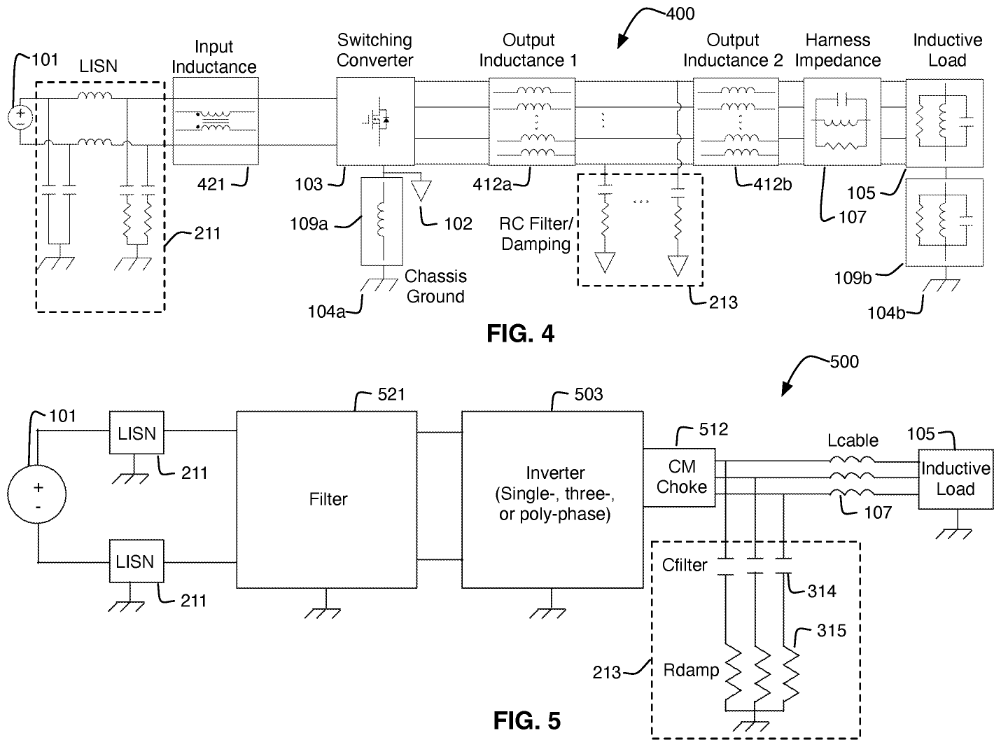

FIG. 4 illustrates one embodiment of common mode noise filtering and damping circuitry for an electrical system 400 having a switching converter 103 driving a wiring harness 107. Electrical system 400 is generally as described above with respect to FIGS. 1-2, with corresponding elements having like reference numbers. Thus, switching converter 103 receives power from voltage source 101 via LISN 211 and an added input inductance 421. Input inductance 421 can be formed in a variety of ways depending on the application. For example, input inductance 421 could include per conductor discrete inductors, ferrite beads, a common mode choke, etc. As before, switching converter is coupled to chassis ground 104a via a parasitic impedance 109a (depicted here as an inductance) between the converters own ground reference/signal ground 102. As was described above, switching converter 103 can take a variety of forms depending on the nature of the electrical system 400, including an AC-DC converter, a DC-DC converter, an AC-AC converter, etc.

To address potential common mode noise issues, a first output inductance 412a can be coupled to the output of switching converter 103, with an RC filter/damping network 213 connected to the other side of the first output inductance 412a, and a second output inductance 412b coupling this junction to the wiring harness 107. As with input inductance 421, the output inductances 412a/412b can be implemented in various forms, including but not limited to per conductor discrete inductors, ferrite beads, a common mode choke, etc. In some embodiments, trace or parasitic inductances may be sufficient. Also, as described above with reference to FIGS. 2 and 3A, RC filter/damping circuit can include a series RC circuit coupling each output conductor of switching converter 103 to the signal ground 102. (In this case, the RC network is coupled to the switching converter output between the two output inductances.)

In other respects, electrical system 400 is as described above, with the filtered output of switching converter 103 being coupled to an inductive load 105 via a wiring harness 107. In the illustration of FIG. 4, the impedances of harness 107 and inductive load 105 are illustrated generically as RLC circuits, with the understanding that the exact impedance of the load is not critical to the teachings herein. Finally, as was described above, inductive load 105 can be coupled to chassis ground 104b via a parasitic impedance 109b, again depicted as a generic RLC circuit, but which may have a variety of specific impedances. In operation, the combination of the output inductances 412a and 412b with RC filter/damping network 213 can reduce the amount of common mode noise associated with operation of switching converter 103, specifically conducted electromagnetic emissions that would otherwise couple to input voltage source 101. Such coupling may be further mitigated by input inductance 421. Additionally, the damping effect of the resistors in RC network 213 can reduce resonance effects as described above with respect to FIGS. 3A-3C.

FIG. 5 illustrates an alternative embodiment of common mode noise filtering and damping circuitry for an electrical system 500 having a switching converter/inverter 503 driving a wiring harness 107. For FIG. 5 and subsequent figures, the schematics described above with respect to FIGS. 2 and 4 have been slightly simplified, although corresponding components retain like reference numbers. As before, a switching converter (in this case an inverter 503 or DC-AC converter) can be a single-, three-, or poly-phase inverter. Inverter 503 can receive its input power from a voltage source 101 via LISNs 211 (with a separate LISN for the positive and negative DC input lines). The DC input may also pass through a filter 521, which can correspond to input inductance 421 described above with reference to FIG. 4. Filter 521 can also be implemented using other filter designs, with the objective being to provide a low pass filter that allows DC to pass from voltage source 101 to inverter 503 while blocking higher frequencies associated with common mode noise and other artifacts associated with the higher frequency switching of inverter 503.

A common mode choke 512 can be coupled to the output of inverter 503. Downstream (i.e., on the load side) of common mode choke 512, an RC filter/damping network 213 can couple to ground. Also downstream of common mode choke 512, the wiring harness 107 is depicted as an inductance Lcable, corresponding to the wiring harness. Although in the above-discussed figures, the harness was depicted as having an arbitrary RLC impedance, for some embodiments (e.g., those using relatively long harnesses) the inductance may be the dominating effect. Finally, at the other end of harness 107 is inductive load 105. Although parasitic impedance 109a between the inverter ground and chassis ground and parasitic impedance 109b between inductive load 105 and chassis ground are omitted from FIG. 5, these elements could nonetheless be present. Also, as above, RC filter/damping network includes filter capacitors Cfilter 314 for each output conductor in series with damping resistors Rdamp 315 for each output conductor. As described above with reference to FIG. 3, the filter capacitors 314 can cooperate with the inductances associated with common mode choke 512 and cable inductance 107 to filter out high frequency common mode noise associated with the switching operation of inverter 503. Additionally, the damping resistors 315 can be used to damp out resonances resulting from the combination of inductive and capacitive elements. Selection of the values of the filter capacitances and damping resistances can be calculated based on the respective impedances, inductances, and switching frequencies of a given application.

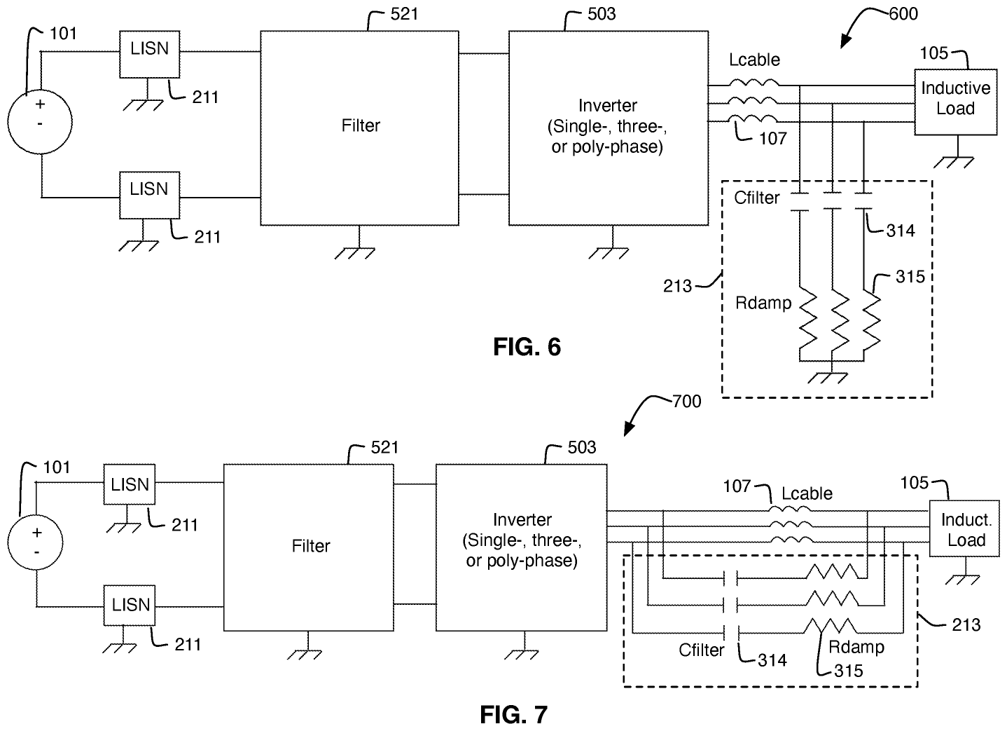

FIG. 6 illustrates another alternative embodiment of common mode noise filtering and damping circuitry for an electrical system 600 having a switching converter/inverter 503 driving a wiring harness 107. FIG. 6 uses the simplified schematic style of FIG. 5, with corresponding components retaining like reference numbers. As before, a switching converter (in this case an inverter 503 or DC-AC converter) can be a single-, three-, or poly-phase inverter. Inverter 503 can receive its input power from a voltage source 101 via LISNs 211 (with a separate LISN for the positive and negative DC input lines). The DC input may also pass through a filter 521, which can correspond to input inductance 421 described above with reference to FIG. 4. Filter 521 can also be implemented using other filter designs, with the objective being to provide a low pass filter that allows DC to pass from voltage source 101 to inverter 503 while blocking higher frequencies associated with common mode noise and other artifacts associated with the higher frequency switching of inverter 503.

In FIG. 6, the separate output inductance has been omitted, and the only inductance on the output of inverter 503 is the cable inductance Lcable of wiring harness 107. In applications where it is possible to design suitable filtering/damping without adding additional inductive elements, there can be advantages such as reduced cost, complexity, cost, weight, component count, etc. RC filter/damping network 213 can couple this inductance to ground, with the harness 107 also being coupled to inductive load 503. Although in the above-discussed figures, the harness was depicted as having an arbitrary RLC impedance, for some embodiments (e.g., those using relatively long harnesses) the inductance may be the dominating effect. Finally, at the other end of harness 107 is inductive load 105. Although parasitic impedance 109a between the inverter ground and chassis ground and parasitic impedance 109b between inductive load 105 and chassis ground are omitted from FIG. 6, these elements could nonetheless be present. Also, as above, RC filter/damping network includes filter capacitors Cfilter 314 for each output conductor in series with damping resistors Rdamp 315 for each output conductor. As described above with reference to FIG. 3, the filter capacitors 314 can cooperate with the inductances associated with common mode choke 512 and cable inductance 107 to filter out high frequency common mode noise associated with the switching operation of inverter 503. Additionally, the damping resistors 315 can be used to damp out resonances resulting from the combination of inductive and capacitive elements. Selection of the values of the filter capacitances and damping resistances can be calculated based on the respective impedances, inductances, and switching frequencies of a given application.

FIG. 7 illustrates yet another alternative embodiment of common mode noise filtering and damping circuitry for an electrical system 700 having a switching converter (inverter 503) driving a wiring harness 107. FIG. 7 also uses the simplified schematic style of FIGS. 5 and 6, with corresponding components retaining like reference numbers. As before, a switching converter (in this case an inverter 503 or DC-AC converter) can be a single-, three-, or poly-phase inverter. Inverter 503 can receive its input power from a voltage source 101 via LISNs 211 (with a separate LISN for the positive and negative DC input lines). The DC input may also pass through a filter 521, which can correspond to input inductance 421 described above with reference to FIG. 4. Filter 521 can also be implemented using other filter designs, with the objective being to provide a low pass filter that allows DC to pass from voltage source 101 to inverter 503 while blocking higher frequencies associated with common mode noise and other artifacts associated with the higher frequency switching of inverter 503.

Like the embodiment discussed above with respect to FIG. 6, the separate output inductance has been omitted from the embodiment of FIG. 7, and the only inductance on the output of inverter 503 is the cable inductance Lcable of wiring harness 107. In applications where it is possible to design suitable filtering/damping without adding additional inductive elements, there can be advantages such as reduced cost, complexity, cost, weight, component count, etc. RC filter/damping network 213 can be coupled across this inductance, with the harness 107 also being coupled to inductive load 503. Although in the above-discussed figures, the harness was depicted as having an arbitrary RLC impedance, for some embodiments (e.g., those using relatively long harnesses) the inductance may be the dominating effect. Finally, at the other end of harness 107 is inductive load 105. Although parasitic impedance 109a between the inverter ground and chassis ground and parasitic impedance 109b between inductive load 105 and chassis ground are omitted from FIG. 7, these elements could nonetheless be present. Also, as above, RC filter/damping network includes filter capacitors Cfilter 314 for each output conductor in series with damping resistors Rdamp 315 for each output conductor. As described above with reference to FIG. 3, the filter capacitors 314 can cooperate with the inductances associated with common mode choke 512 and cable inductance 107 to filter out high frequency common mode noise associated with the switching operation of inverter 503. Additionally, the damping resistors 315 can be used to damp out resonances resulting from the combination of inductive and capacitive elements. Selection of the values of the filter capacitances and damping resistances can be calculated based on the respective impedances, inductances, and switching frequencies of a given application.

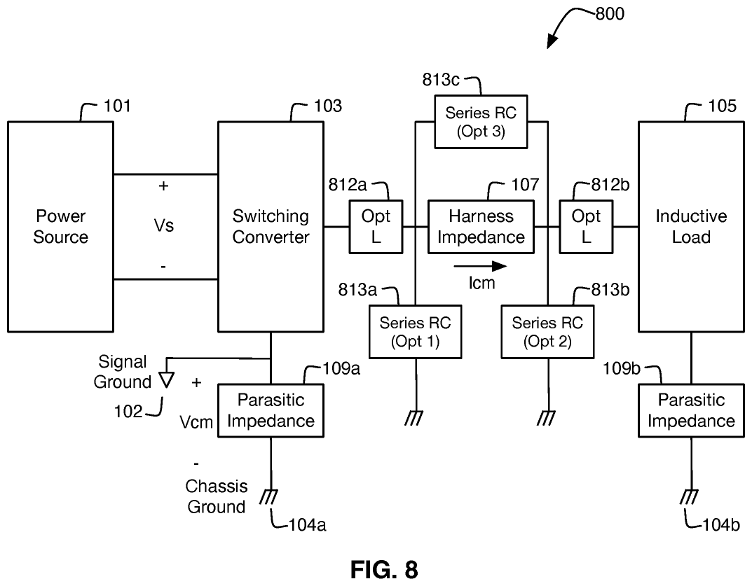

FIG. 8 illustrates a generalized diagram of an electrical system 800 having a switching converter 103 driving a wiring harness 107 having sufficient length to potentially contribute to common mode noise, with added common mode noise filtering and damping circuitry as described herein. FIG. 8 is similar to FIG. 1, with corresponding components having like reference numbers. FIG. 8 thus illustrates an electrical system 800 having a switching converter 103 driving an inductive load 105 via wiring harness 107 having sufficient length to potentially contribute to common mode noise. Electrical system 800 can include a power source 101. Power source 101 can be an AC source or a DC source that provides a source voltage Vs. Power source 103 can provide power to a switching converter 103. Switching converter 103 can convert power received from power source 101 into a form suitable for powering a load, such as inductive load 105. This can include producing a regulated output voltage and/or regulated output current that are suitable for the load, which may vary in response to loading conditions, etc.

In some embodiments, the switching converter can be an inverter that converts a DC voltage received from the power source to an AC voltage to drive the load. In other embodiments, the switching converter could be a DC-DC converter that converts a DC voltage received from power source 101 into a suitable voltage for a load 105. In the case of an inverter, switching converter can have a number of topologies, such as half-bridge or full-bridge inverter, and could be single-phase, split-phase, three-phase, or polyphase. Likewise in the case of a DC-DC converter, switching converter can have various topologies, such as a buck (step-down) converter, boost (step-up) converter, forward resonant converter, etc. The teachings herein are applicable to any such converters, and thus the construction details of switching converter 103 are not discussed in detail herein.

Switching converter 103 can have its own ground reference, denoted signal ground 102 in FIG. 1. This ground reference (signal ground 102) may also be coupled to a chassis ground 104a. Chassis ground 104a can be the ground reference for electrical system 100 as a whole. This may be an earth ground in some applications or may be a chassis ground that is not bonded to earth ground in other applications. The coupling between signal ground 102 and chassis ground 104a can be via a parasitic impedance 109a. This parasitic impedance may come, for example, from the impedance of a grounding strap that couples a case or housing of switching converter 103 to the chassis ground 104a. In some applications, the inductance component of parasitic impedance 109a can combine with the load impedance (discussed below) and wiring harness impedance (discussed above) to contribute to common mode noise issues.

Switching converter 103 can drive a load, such as inductive load 105, via a wiring harness 107. Such wiring harnesses can be used in many applications to route one or more conductors between two or more devices. The wiring harness may include multiple conductors having sufficient length to reach the load (or other destination). Wiring harness 107 may have a certain impedance associated therewith. For example, the wiring harness may exhibit a resistance that is proportional to its length and inversely proportional to the cross-sectional area of the conductors. Additionally, wiring harness 107 may also exhibit reactance, which can be a combination of capacitive reactance caused by capacitive coupling between the conductors and/or inductive reactance caused by the inductance (including both self-inductance and mutual inductance) between the conductors. The resistive and reactive components may change both with length of wiring harness 107 and with the operating frequency of switching converter 103. In some cases, these reactive components may also be affected by the routing of the harness, i.e., the shape of the path that the conductors take. In general, a combination of increasing length of the wiring harness and/or increasing switching frequency of switching converter 103 can contribute to common mode noise issues in electrical system 800.

Electrical system 100 can include a load, such as inductive load 105, that receives power from power source 101 via switching converter 103. Inductive loads are common in many applications. Electric motors are one example of an inductive load. Solenoids are another example. Many other types of inductive loads are also possible. In the exemplary electrical system 100, inductive load 105 is coupled to a chassis ground 104b via a parasitic impedance 109b. As described above, the chassis ground is the ground reference for the electrical system as a whole, which may be an earth ground in some applications, or may be a chassis ground that is not bonded to earth ground in other applications. This parasitic impedance may come, for example, from the impedance of a grounding strap that couples a case or housing of inductive load 105 to the chassis ground 104b. In some applications, the inductance component of parasitic impedance 109b can combine with the load impedance and wiring harness impedance to contribute to common mode noise issues.

The inductance or inductive reactance of inductive load 105 can combine with the impedance of wiring harness 107 and the parasitic impedances 109a and 109b to contribute to common mode noise issues associated with operation of switching converter 103. For example, the impedances of inductive load 105, wiring harness 107, and parasitic impedances 109a/109b can combine to produce a resonant frequency for the overall system. If this resonant frequency is sufficiently close to the switching frequency of switching converter 103, noise associated with the switching operation can manifest itself as common mode noise in the form of a common mode noise current Icm (illustrated as flowing through the harness 107) and/or as a common mode voltage Vcm appearing across the parasitic impedance 109a, i.e., between signal ground 102 (the “internal” ground of switching converter 103) and chassis ground 104a. In many applications, this common mode noise, in the form of conducted electromagnetic emissions, may be exacerbated by various physical parameters associated with the wiring harness, including length, routing, etc. Thus, it may be desirable to provide some sort of filtering and/or damping to mitigate these issues.

As described above with respect to FIGS. 2-7, the filtering and or damping can take a variety of forms. For example, additional inductances 812a or 812b may be provided in series with the wiring harness 107. These additional inductances can take various forms, such as the single output inductance 212 of FIG. 2, the dual output inductances 412a/412b of FIG. 4, the common mode choke 512 of FIG. 5, etc. Alternatively, the additional output inductance can be omitted, and the filtering/damping circuit can be designed around just the parasitic inductances, such as the harness inductance Lcable as described above with reference to FIGS. 6-7. Additional RC filter/damping circuitry 813a, 813b, 813c can also be provided, as described in each of the above-described embodiments. RC filter/damping circuitry can be implemented as a series RC circuit with a filter capacitance and damping resistance selected to achieve the desired conducted EMI/common mode noise reduction. As described in the various embodiments, the RC filter/damping circuitry can couple either the converter side or load side of harness 107 to ground, which can be either the chassis ground 104a/104b or the signal ground 102 associated with switching converter 103. In other embodiments the RC filter network can be coupled in parallel with the harness 107. Also discussed above with respect to FIGS. 4-7 but not depicted in FIG. 8 is additional filtering on the input side of switching converter 103, i.e., between power source 101 and the input of switching converter 103. Various permutations and combinations of such arrangements may be advantageously employed to achieve the desired common mode noise reduction in a variety of applications.

The foregoing describes exemplary embodiments of common mode nose/conducted EMI filtering circuits that can allow for improved operation of electrical systems including switching converters that power inductive loads via wiring harnesses, including relatively long wiring harnesses. Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. An electrical system comprising:
an inductive load;
a switching converter that receives power from a power source and converts it to a voltage or current level suitable for the inductive load;
a wiring harness having a first end coupled to an output of the switching converter and a second end coupled to the inductive load; and
an RC filter network coupled to at least one end of the wiring harness, the RC filter network having a filter capacitance and a damping resistance, wherein the filter capacitance and damping resistance are selected to reduce common mode noise caused by conducted electromagnetic emissions associated with switching operation of the switching converter.

2. The electrical system of claim 1 wherein the RC filter network further comprises one or more series combinations of the filter capacitance and the damping resistance.

3. The electrical system of claim 2 wherein the series combinations of the filter capacitance and the damping resistance couple each power conductor of the wiring harness to a signal ground associated with the switching converter or a chassis ground associated with the electrical system.

4. The electrical system of claim 1 wherein the RC filter network is coupled in parallel with the wiring harness coupling a first end of each power conductor of the wiring harness to a second end of each power conductor of the wiring harness.

5. The electrical system of claim 1 further comprising at least one of a first inductance coupled between the output of the switching converter and the first end of the wiring harness and a second inductance coupled between the second end of the wiring harness and the inductive load.

6. The electrical system of claim 5 wherein at least one of the first and second inductances is selected from the group consisting of: discrete inductors, ferrite beads, and a common mode choke.

7. The electrical system of claim 1 further comprising a filter coupled between an input of the switching converter and the power source.

8. The electrical system of claim 1 wherein the switching converter is an inverter.

9. The electrical system of claim 1 wherein the inductive load is a motor.

10. The electrical system of claim 1 wherein the switching converter is a solenoid.

11. An electrical system comprising:
an inductive load;
a switching converter that receives power from a power source and converts it to a voltage or current level suitable for the inductive load;
a wiring harness having a first end coupled to an output of the switching converter and a second end coupled to the inductive load;
a first output inductance coupled between the switching converter and the first end of the wiring harness; and
an RC filter network coupled to the first output inductance and the first end of the wiring harness, the RC filter network further comprising a filter capacitance and a damping resistance selected to reduce common mode noise caused by conducted electromagnetic emissions associated with switching operation of the switching converter.

12. The electrical system of claim 11 further comprising a filter coupled between the switching converter and the power source.

13. The electrical system of claim 12 wherein the filter coupled between the switching converter and the power source is an input inductance.

14. The electrical system of claim 11 wherein the first output inductance is a common mode choke.

15. The electrical system of claim 11 further comprising a second output inductance coupled between the second end of the wiring harness and the inductive load.

16. The electrical system of claim 11 wherein the RC filter network further comprises a series combination of a filter capacitance and a damping resistance coupling each power conductor of the wiring harness to a signal ground associated with the switching converter or a chassis ground associated with the electrical system.

17. An electrical system comprising:
an inductive load;
a switching converter that receives power from a power source and converts it to a voltage or current level suitable for the inductive load;
a filter coupled between the switching converter and the power source;
a wiring harness having a first end coupled to an output of the switching converter and a second end coupled to the inductive load; and
an RC filter network coupled to at least one end of the wiring harness, the RC filter network having a filter capacitance and a damping resistance selected to reduce common mode noise caused by conducted electromagnetic emissions associated with switching operation of the switching converter.

18. The electrical system of claim 17 wherein the filter coupled between the switching converter and the power source is an input inductance.

19. The electrical system of claim 17 wherein the RC filter network couples each power conductor of the wiring harness to a signal ground associated with the switching converter or a chassis ground associated with the electrical system.

20. The electrical system of claim 17 wherein the RC filter network is coupled in parallel with the wiring harness coupling a first end of each power conductor of the wiring harness to a second end of each power conductor of the wiring harness.
